(19) United States
(12) Patent Application Publication
(10) Pub. No.: US 2008/0065439 A1
(43) Pub. Date: Mar. 13, 2008

(54) METHODS, SYSTEMS, AND COMPUTER PROGRAM PRODUCTS FOR IMPLEMENTING PURCHASE CONTROL SERVICES

(75) Inventors: Steven G. Daren, New London, CT (US); James G. Evans, Naples, FL (US); Mitchell W. Miller, New York, NY (US); Steven J. Tedisky, Groton, CT (US)

Correspondence Address: CANTOR COLBURN, LLP, 20 Church Street, 22nd Floor, Hartford, CT, 06103, US

(73) Assignee: BUYERS EDGE LLC, Waterford, CT (US)

(21) Appl. No.: 11/842,295

(22) Filed: Aug. 21, 2007

Related U.S. Application Data
(60) Provisional application No. 60/813,609, filed on Sep. 8, 2006.

(51) Int. Cl. G06Q 10/00

(52) U.S. Cl. 705/7

(57) ABSTRACT

Methods, systems, and computer program products for implementing purchase control services are provided. A method includes generating a record for a business agreement established between a customer and a supplier, and entering terms of the business agreement into corresponding data fields. The method also includes linking key data fields in the record to one or more information sources. In response to receiving an item from the supplier entity, the method includes creating a standardized record for the item, mapping the standardized record to at least one of the information sources and the record, reviewing the item for missing and incorrect data and supplying missing or correct data to the standardized record from at least one of the information sources. The method further includes comparing data in the standardized record with data provided in one of the pricing schedule and the record and resolving discrepancies, if discovered, in response to the comparing.

This application claims priority to U.S. Provisional Application No. 60/813,609, filed on Sep. 8, 2006, the contents of which are incorporated by reference herein in its entirety.

### BACKGROUND OF THE INVENTION

The present disclosure relates generally to supply chain processes and, in particular, to methods, systems, and computer program products for implementing purchase control services for enterprises and their supply chain partners.

Continuous advancements made in the fields of Internet technologies and related communications technologies have steadily paved the way for a variety of new and useful inter- and intra-enterprise solutions. Economic factors, such as rising fuel costs, have reduced margins and made prices in areas like foodservice more volatile and market-sensitive. In order to stay competitive, and to control costs, business enterprises must keep abreast of these advancements and utilize them to seek out ways to improve various business functions in order to reduce costs and provide the most value to customers.

Most business enterprises rely upon, and collaborate with, third parties (e.g., trading partners, suppliers, manufacturers, outsourced entities, etc.) to conduct business and realize goals. Advancements in Internet technologies, such as open source protocols, have enabled communications among these parties that were never before possible due to, e.g., disparate legacy systems.

Despite these advancements, however, many business enterprises find that there is lacking flexible and scalable solutions that fully address their unique business needs. For example, a large enterprise with dozens of satellite facilities (or chain of establishments) needs to centrally manage volumes of transactions conducted among each of the facilities and their respective trading partners. With each facility there may be multiple and overlapping purchasing agreements between the facility and its suppliers. Each agreement, in turn, can be complex (e.g., with varying terms and conditions), which can change over time. The challenge is magnified in industries where purchasing is highly dynamic.

What is needed, therefore, is an automated system for managing purchase control functions for business enterprises.

### BRIEF SUMMARY

Methods, systems, and computer program products for implementing purchase control services are provided. A method includes generating a record for a business agreement established between a customer and a supplier, and entering terms of the business agreement into corresponding data fields. The method also includes linking key data fields in the record to one or more information sources. In response to receiving an item from the supplier entity, the method includes creating a standardized record for the item, mapping the standardized record to at least one of the information sources and the record, reviewing the item for missing and incorrect data and supplying missing or correct data to the standardized record from at least one of the information sources. The method further includes comparing data in the standardized record with data provided in one of the pricing schedule and the record and resolving discrepancies, if discovered, in response to the comparing.

A system for implementing purchase control services includes a host system implementing a purchase control application. The purchase control application performs a method. The method includes generating a record for a business agreement established between a customer and a supplier, and entering terms of the business agreement into corresponding data fields. The method also includes linking key data fields in the record to one or more information sources. In response to receiving an item from the supplier entity, the method includes creating a standardized record for the item, mapping the standardized record to at least one of the information sources and the record, reviewing the item for missing and incorrect data and supplying missing or correct data to the standardized record from at least one of the information sources. The method further includes comparing data in the standardized record with data provided in one of the pricing schedule and the record and resolving discrepancies, if discovered, in response to the comparing.

A computer program product for implementing purchase control services includes instructions for causing a computer to implement a method. The method includes generating a record for a business agreement established between a customer and a supplier, and entering terms of the business agreement into corresponding data fields. The method also includes linking key data fields in the record to one or more information sources. In response to receiving an item from the supplier entity, the method includes creating a standardized record for the item, mapping the standardized record to at least one of the information sources and the record, reviewing the item for missing and incorrect data and supplying missing or correct data to the standardized record from at least one of the information sources. The method further includes comparing data in the standardized record with data provided in one of the pricing schedule and the record and resolving discrepancies, if discovered, in response to the comparing.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a block diagram of a system upon which the purchase control services may be implemented in exemplary embodiments;

FIGS. 2A-2B illustrate a flow diagram that describes a process for implementing the purchase control services with respect to pricing schedules in exemplary embodiments;

FIGS. 3A-3B illustrate a flow diagram that describes a process for implementing the purchase control services with respect to invoicing in exemplary embodiments;

FIG. 4 is a computer screen shot depicting a sample menu of options selectable for launching various functions provided by the purchase control services in exemplary embodiments;

FIG. 5 is a computer screen shot depicting a supplier invoice record and sample invoice data in exemplary embodiments;

FIG. 6 is a computer screen shot depicting a listing of invoice records pending processing and resolution in exemplary embodiments; and

FIG. 7 is a computer screen shot depicting a sample manufacturer record in exemplary embodiments.

The detailed description explains the exemplary embodiments of the invention, together with advantages and features, by way of example with reference to the drawings.

### DETAILED DESCRIPTION OF THE INVENTION

Purchase control services are provided in accordance with exemplary embodiments. The purchase control services provide an automated system for assisting enterprises in managing business transactions and ensuring that associated trading partners are in compliance with various terms and conditions provided in business agreements that have been established among the respective parties. The purchase control services described herein may be utilized for a variety of industries and are particularly well suited for industries in which product pricing is volatile (e.g., food services). As such, the purchase control services will be described herein with respect to a food/restaurant industry for purposes of illustration. In this example, various inter-enterprise parties may participate in the purchase control services, such as customers (represented, e.g., as restaurants, hotels, hospitals, universities, government, etc.) and suppliers, such as manufacturers, distributors, and brokers, to name a few.

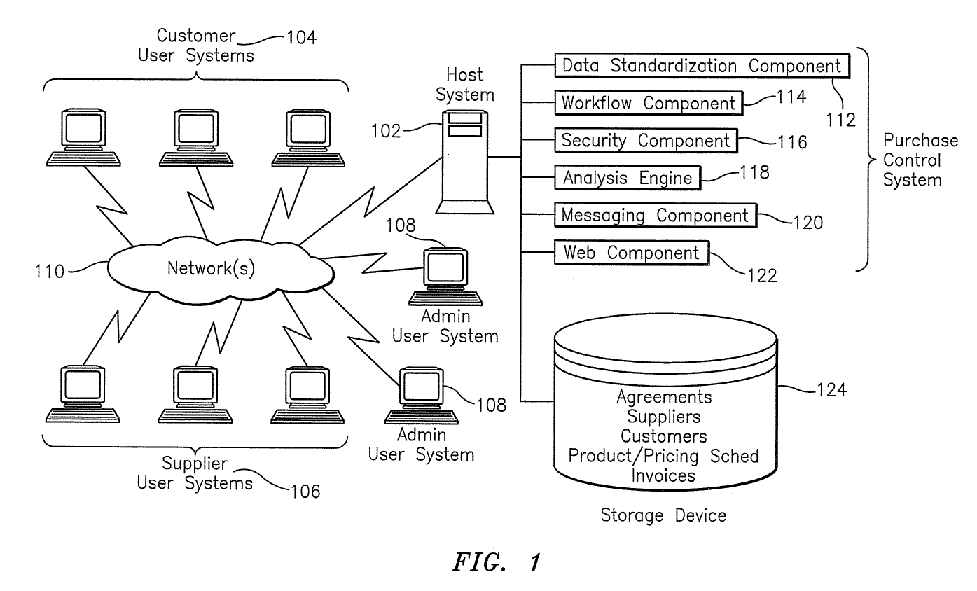

Turning now to FIG. 1, a system upon which the purchase control services may be implemented in accordance with exemplary embodiments will now be described. The system of FIG. 1 includes a host system 102 in communication with customer user systems 104, supplier user systems 106, and administrative user systems 108, over one or more networks 110. Host system 102 may be implemented by, e.g., a business enterprise whereby the host system 102 refers to a centralized processing system that manages the purchase control activities of the business on behalf of its facilities (e.g., customer user systems 104). Alternatively, host system 102 may be administered by an application service provider (ASP) that hosts purchase control services for subscribing entities, e.g., customer user systems 102 (whereby each of customer user systems 102 represents a separate business enterprise). Host system 102 may be implemented using one or more servers operating in response to a computer program stored in a storage medium accessible by the server(s). The host system 102 may operate as a network server (e.g., a web server) to communicate with the network entities (e.g., customer user systems 104, supplier user systems 106, and administrative user systems 108). The host system 102 handles sending and receiving information to and from the network entities 104-108 and can perform associated tasks. The host system 102 executes a suite of applications, including the product control system, to provide the services described herein.

Customer user systems 104 include subscribers of the purchase control services provided by host system 102. Subscribers refer to those individuals and/or entities that subscribe (e.g., register) to receive and participate in the purchase control services provided by the host system 102 as described further herein. Supplier user systems 106 refer to trading partners of the customer user systems 104 (e.g., in the above example, suppliers provide foods, food-related products, and food-related services to customers). Customer user systems 104 and supplier user systems 106 may be situated in widely remote locations around the globe.

Administrative user systems 108 may be administered by representatives (e.g., employees) of the host system 102 enterprise. Administrative user systems 108 provide support functions relating to the purchase control system activities as described further herein. Each of customer user systems 104, supplier user systems 106, and administrative user systems 108 may be implemented using a general-purpose computer executing a computer program for carrying out at least a portion of the processes described herein. The user systems 104-108, e.g., may be personal computers that are implemented in a wireline or wireless fashion (e.g., a lap top, a personal digital assistant, tablet PC, etc.) or host attached terminals. If the user systems 104-108 are personal computers, the processing described herein may be shared by one or more of the user systems 104-108 and the host system 102 (e.g., by providing an applet to the user systems 104-108). Alternatively, a portion of the processing described herein may be performed via a client application executing on one or more of the user systems 104-108.

While only three each of customer user systems 104 and supplier user systems 106 are shown for ease of illustration in the system of FIG. 1, it will be understood that many customer and supplier systems may be implemented in order to realize the advantages of the purchase control services.

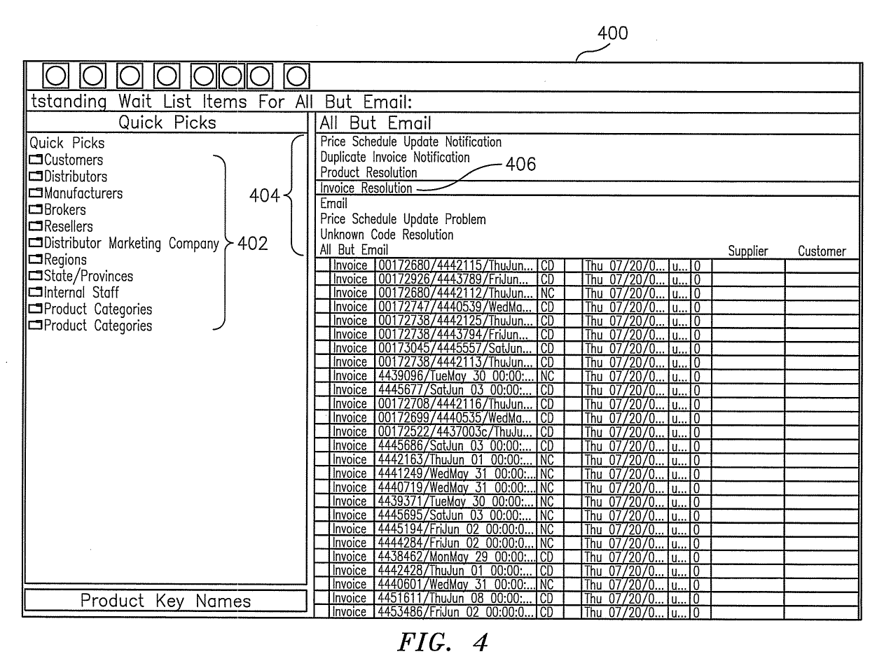

The purchase control system provides a common user interface from which various administrative functions may be launched. A sample user interface is shown in FIG. 4. The purchase control services are facilitated through the suite of applications 112-122. By selecting one or more options provided in the computer screen window 400, an administrative user system 108 can initiate the features and functions available via the purchase control services described herein.

Features and functions provided by the purchase control services include by way of non-limiting examples: data standardization, product information management, centralized bid/ask (reverse auction), purchase processes, workflow management, data/system security, data analysis, and messaging with respect to purchase transactions between a customer and its trading partners.

The host system 102 is in communication with redundant data storage facility 124. In exemplary embodiments, the storage facility 124 is in direct communication with the host system 102 (via, e.g., cabling). However, other network implementations may be utilized. For example, storage device 124 may be logically addressable as a consolidated data source across a distributed environment that includes one or more networks 106. Information stored in the storage device 124 may be retrieved and manipulated via the host system 102. Storage device 124 stores a variety of information for use in implementing the purchase control services. As shown in FIG. 1, storage device 124 stores customer agreements, supplier demographics and other information, customer demographics and other information, product/pricing information (e.g., product catalogs and price schedules), transaction histories, and invoice data. Customer and supplier information may include, e.g., identification information, notification means, such as IP routing addresses, email addresses, primary points of contact, etc. that are utilized by the messaging component 120 as described herein.

Network(s) 106 may be any type of known network including, but not limited to, a wide area network (WAN), a local area network (LAN), a global network (e.g. Internet), a virtual private network (VPN), and an intranet. The network(s) 106 may be implemented using a wireless network or any kind of physical network implementation known in the art. A user system 104-108 may be coupled to the host system 102 through multiple networks (e.g., intranet and Internet) so that not all user systems 104-108 are coupled to the host system 102 through the same network. In one embodiment, the network is an intranet and one or more user systems 104-108 execute a user interface application (e.g. a web browser) to contact the host system 102 through the network 106 while another user system, e.g., administrative user system 108, may be directly connected to the host system 102.

The nature of the services provided by the purchase control system depends upon the particular user system. For example, a customer user system 104 may have access to purchase transaction information relating to activities between itself and its suppliers (or between its facilities and associated suppliers). A supplier, on the other hand, may have limited access to transactions conducted between it and the customers it services. This information may be facilitated via an access-restricted Web component 122 of the purchase control system. An administrative user system 108 may have extended access to all information relating to a set of customers, or customers within a geographic area, etc., for which it is responsible.

As indicated above, the purchase control services are facilitated via an automated system that assists enterprises in managing business transactions and ensures that associated trading partners are in compliance with various terms and conditions provided in business agreements that have been established among the respective parties. The purchase control system creates a database of customer records (also referred to herein as ‘customer database’) that includes, e.g., name, address, contact information, etc. for which it services. A database is also created for storing agreements established among these parties. The agreements may be verbal or written. If written, the data standardization component 112 processes the agreements in order to manipulate the invoice data into a standardized format for processing. If the agreements are verbal, a manual entry process may be used for creating a record. The agreement records include data fields of which one or more are linked to records stored in other databases of storage device 124. For example, a data field ‘SUPPLIER_ID’ in an agreement record may be linked to a corresponding supplier record, as well as a customer record that has entered into an agreement with the particular supplier. In addition, a product database may be utilized that stores a variety of product information, e.g., product ID, product description, unit of sale, cost per unit, shipping information, etc. Pricing information includes, e.g., pricing schedules provided and updated periodically by suppliers for their respective customers. For example, a pricing schedule may include information, such as product identification, product description, quantity ordered, base cost (e.g., 8% above supplier's cost), rebate information, buyback information, program data, and other terms/conditions that may change over time.

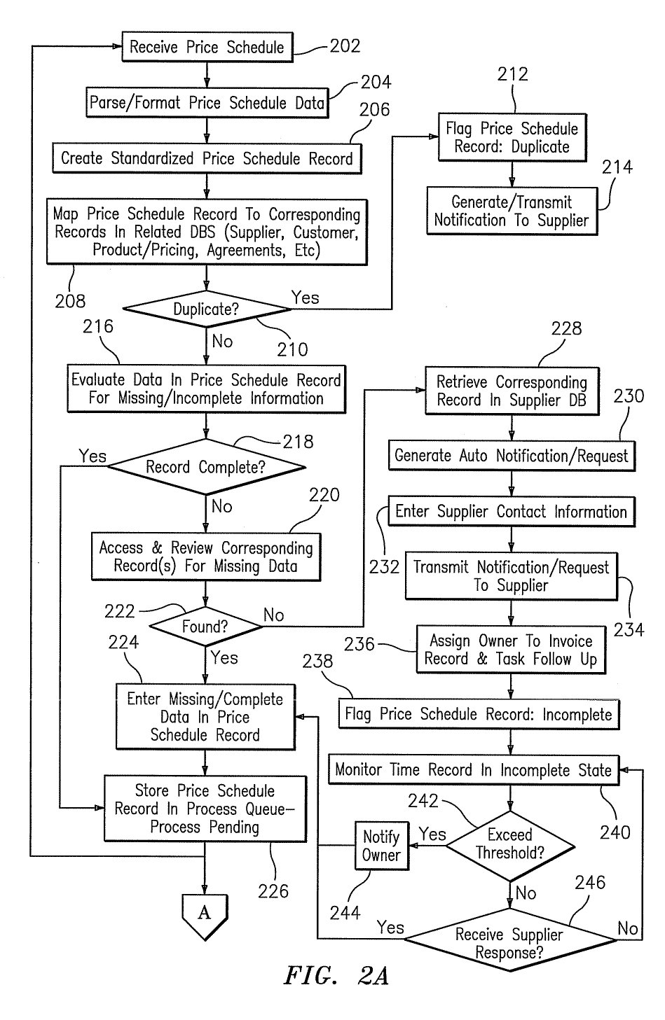

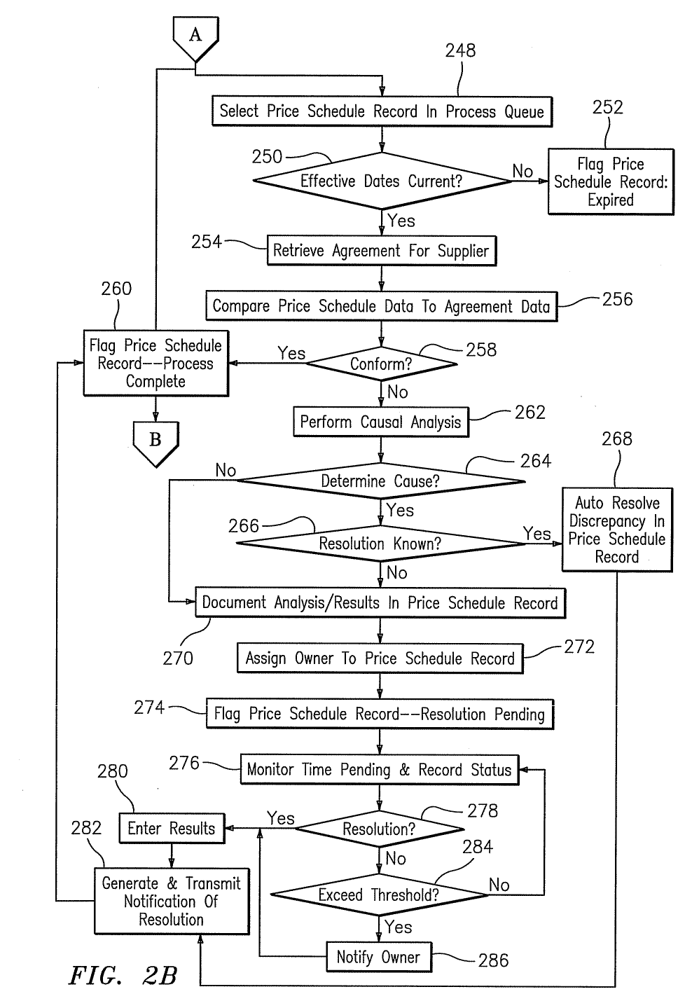

Invoices are received from suppliers at the host system 102 and are processed by the purchase control system. Invoices are restructured in a similar manner as that described above with respect to the agreements. The purchase control system processes the invoices, agreements, and related information in order to determine whether suppliers are in compliance with the established agreements. Any discrepancies between invoice information and an agreement is analyzed by the purchase control system (via the analysis engine 118) in order to resolve the discrepancies. If the purchase control system is not able to resolve a discrepancy, it utilizes administrative user systems 108 in conjunction with workflow component 114, security component 116, and messaging component 120 to facilitate a resolution as described herein. These, and other features and functions will be described further in the flow diagrams of FIGS. 2A-2B and the related computer screen windows of FIGS. 4 through 7.

Turning now to FIG. 2, a flow diagram describing a process for implementing the purchase control services with respect to price schedules will now be described in accordance with exemplary embodiments. At step 202, the host system 102 receives a price schedule from one of supplier user systems 106. The data standardization component 112 parses the price schedule and formats the parsed data using a standardized formatting scheme at step 204. At step 206, a price schedule record is created for the price schedule. Typical data stored in a price schedule record may include supplier information, customer information, product ID, product description, quantity ordered, quantity delivered, unit of sale, cost per unit, etc.

At step 208, the price schedule record is mapped to corresponding records in related databases (e.g., supplier, customer, product/pricing, agreements, etc.) via one or more data fields. At step 210, it is determined whether the price schedule is a duplicate of a previous price schedule received at the host system 102. This may occur when a supplier inadvertently sends a duplicate pricing schedule or if the purchasing control system inadvertently attempts to re-process an existing pricing schedule. The purchasing control system may identify a duplicate pricing schedule by utilizing an algorithm which hashes key data and metadata in the received pricing schedule record, and generates a unique value. If the price schedule is determined to be a duplicate of an existing price schedule, the price schedule record for the schedule received at step 202 is marked as ‘duplicate’ in the database at step 212 and a notification of the duplication (if due to supplier error) is generated and transmitted to the supplier at step 214.

If the price schedule record is considered not to be a duplicate at step 210, the purchase control system evaluates the data in the price schedule record for any missing or incomplete information at step 216 (e.g., unit of cost missing; unrecognized product description or identifier, etc.). If the record is incomplete at step 218, the purchase control system retrieves one or more records from related databases (e.g., product/pricing, catalog information, agreements, etc.) to determine whether the information can be obtained elsewhere at step 220. For example, a product description may be provided in the price schedule record but a product ID is missing. The purchase control system accesses the product database in storage device 124 for the given supplier identifier and searches for the product description or the closest match to the product description.

At step 222, it is determined whether the missing/incomplete information is found. If so, the missing/correct information is entered into the price schedule record at step 224. Once the price schedule record is complete, or alternatively, if at step 218 the record is already complete, it is stored in a process queue within host system 102 where it awaits further processing at step 226 and the process continues in FIG. 2B. Additionally, the process returns to step 202 as new price schedules are received at the host system 102.

Returning now to step 222, if the missing information is not found elsewhere in storage device 124, supplier information is acquired by retrieving a supplier record for the supplier at step 228. The purchase control system generates a notification that specifies what information is needed at step 230 and enters the supplier contact information (e.g., point of contact name, email address, instant messaging address, etc.) at step 232. At step 234, the notification is transmitted via messaging component 120 to the supplier (e.g., one of supplier user systems 106). The purchase control system then assigns an owner (e.g., one of administrative user systems) to the price schedule record via workflow component 114 and tasks it for follow up at step 236. Alternatively, the owner may be an automated intelligent agent that performs a defined series of steps in order to resolve the issue pending in the price schedule record. The price schedule record is flagged ‘incomplete’ while the purchase control system waits for a response from the supplier or until another resolution takes place at step 238. The purchase control system monitors the time that the price schedule record is in this state (incomplete) at step 240. The purchase control system may be configured such that a preset time limit is used as a triggering event with respect to the price schedule record while in this ‘incomplete’ state. At step 242, it is determined whether a threshold of time has been reached. If so, an automated notification is generated and transmitted to the owner at step 244. At this time, the owner takes action to obtain the missing/incomplete information, which may involve, e.g., one or more communications with the supplier. Once the information is obtained (e.g., missing data is received) from the supplier user system 106 at step 246, or as a result of the owner notification at step 244, the missing/complete information is entered into the price schedule record at step 224 and the process continues as shown in FIG. 2A.

As indicated above, once the price schedule record is complete, it is placed in a process queue at the host system 102 where it awaits further processing. This further processing determines whether any discrepancies exist with respect to the price schedules and attempts to resolve the discrepancies, if found, as will now be described in FIG. 2B.

At step 248, the purchase control system selects a price schedule record to process. The price schedule record is examined to determine the effective dates. The effective dates specify the duration of the terms of the items (products, costs, rebates, etc.) presented therein. It is then determined whether these effective dates are current at step 250. If not, the price schedule record is flagged ‘expired’ at step 252. Otherwise, the purchase control system identifies an agreement (e.g., contract) associated with the supplier for the price schedule record.

At step 254, the agreement is retrieved from the agreements database in storage device 124. At step 256, the price schedule data is compared to the data in the agreement. This step may involve a simple calculation (e.g., a match is found between corresponding data fields) or may be a very complex analysis whereby various pricing schemes (e.g., rebates, buy backs, etc.), varying time- or volume-based discount programs, and other items need to be parsed and reconciled before a fair comparison can be made.

As a result of the analysis, it is determined whether the price schedule data is in conformance with the agreement at step 258. If so, this means that the supplier's price schedule is in compliance with the agreement established between the supplier and the customer. In this instance, the price schedule record is then marked or flagged indicating that the price schedule processing is complete at step 260 and the method returns to step 248 whereby the purchase control system selects another price schedule record to process.

If however, the price schedule data does not conform to the agreement at step 258, the purchase control system performs a causal analysis at step 262 in order to trouble shoot the discrepancy. For example, suppose that the agreement indicated that effective dates of pricing schedules were guaranteed to extend for a minimum of five business days. Suppose also that the price schedule reflected effective dates extending for a period of four days. The purchase control system may troubleshoot for determining a cause of the discrepancy (e.g., it may be that the price schedule falls on a holiday week and the agreement terms specify that holidays are excluded from the guaranteed dates). In this case, the analysis engine 118 of the purchase control system attempts to resolve the discrepancy using one of several techniques. For example, the analysis engine 118 may search the agreement record for terms that provide for holiday exemptions with respect to the pricing agreements. Alternatively, if the discrepancy relates to another matter, the analysis engine 118 may be configured to search other database records and perform comparisons (depending upon the nature of the discrepancy) and attempt to rectify it. As a result of this analysis, it is determined whether a cause is established at step 264. Using the above example, purchase control system looks to the agreement to determine whether the terms specify that holidays are exempt from the price schedule effective dates. If so, the purchase control system may then determine if a holiday occurs during the period of time in question. If so, the purchase control system determines that this is the cause of the discrepancy.

Once a cause has been determined at step 264, it is determined whether a resolution is known for the issue at step 266. Again, using the above example, the resolution may be to modify the pricing schedule effective dates to reflect a term of four days rather than five. In this manner, since a resolution is known at step 266, the purchase control system automatically resolves the discrepancy (e.g., modifying the terms of the price schedule in the record to reflect four days by editing data fields in the price schedule to reconcile it with the agreement) at step 268. If a resolution is not known at step 266 (e.g., the agreement is silent as to whether holidays are exempt), or alternatively, if the cause has not been determined at step 262, the analysis results are recorded in the price schedule record for future reference, if needed, at step 270. Various methods may be employed for determining causes and resolutions. For example, a learning algorithm may be employed that reviews historical information (such as the results of analyses recorded in step 270 over time), which tracks solutions that have been tried and successful.

The purchase control system then generates and transmits a notification of the resolution to the appropriate entities (e.g., the customer and supplier) at step 260 and the process returns to step 242.

At step 272, an owner (e.g., one of administrative user systems 108, or alternatively, an intelligent agent) is assigned to the invoice record via the workflow component 114 and the price schedule record is flagged to reflect ‘pending resolution’ at step 274. The purchase control system tracks the amount of time that the record is pending in this state at step 276. While the record is pending, the owner attempts to acquire the information that would lead to a resolution. This may be implemented via manual analysis of the discrepancy and related data and/or by contact with the supplier, if needed, or by physical audit. If a resolution has been determined at step 278, or alternatively, returning to step 268, if the discrepancy has been automatically resolved, the results are entered into the price schedule record at step 280 and the purchase control system generates and transmits a notification of the resolution to the associated supplier system at step 282.

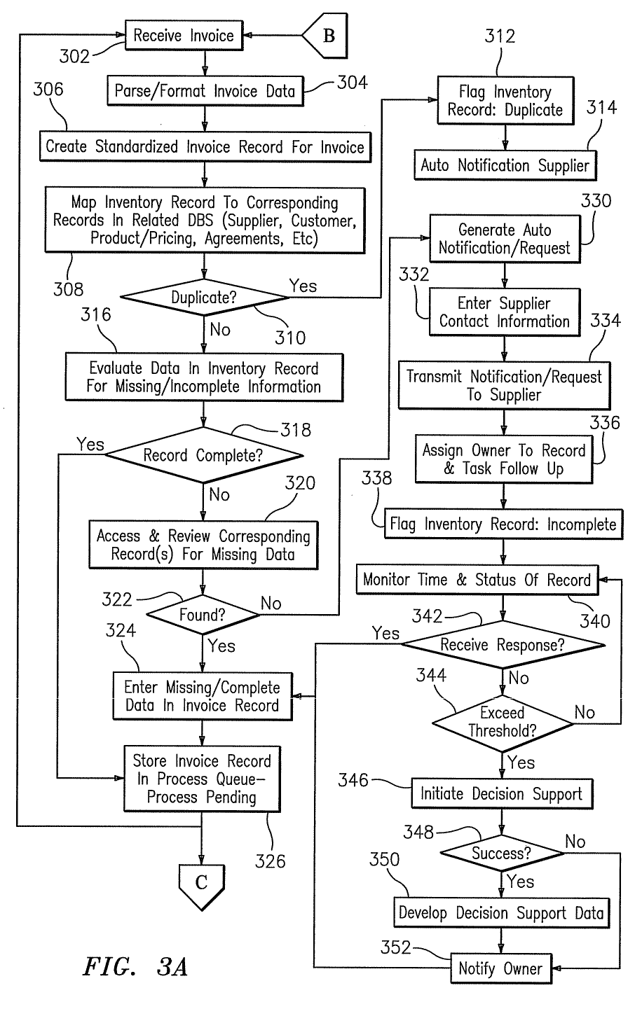

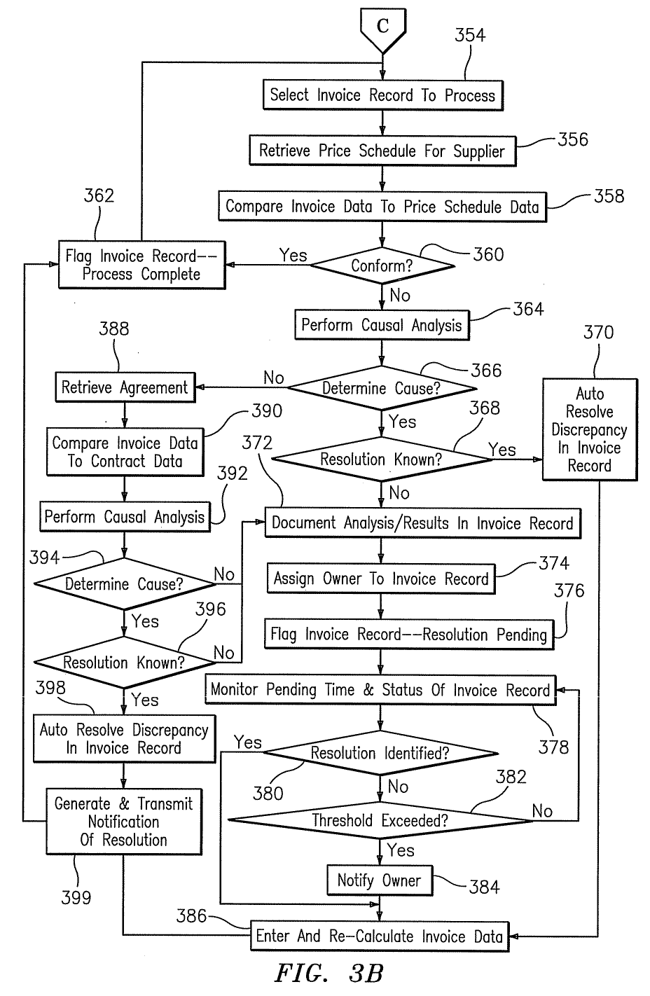

If, on the other hand, a resolution has not been determined at step 278, the workflow component determines if the time threshold has been exceeded at step 284. If not, the process returns to step 276 whereby the status of the record continues to be monitored. Otherwise, at step 286, the owner is notified that a resolution has not been determined and that the record has been in this pending state for an excessive time. The owner then is tasked with acquiring the information needed to resolve the discrepancy. Once the information has been obtained, the results are entered into the price schedule record at step 280 and a notification of the resolution is generated and transmitted to the supplier at step 282. Once the resolution has been determined and entered into the record, and a notification sent to the supplier, the price schedule record is updated to reflect ‘process complete’ at step 260. The process then returns to step 248 where another price schedule record is selected for processing. In addition, the process continues on to FIG. 3A.

Turning now to FIG. 3, a flow diagram describing a process for implementing the purchase control services with respect to invoice processing will now be described in accordance with exemplary embodiments. The purchase control services include a decision support feature (e.g., via the analysis engine 118) whereby automated attempts to resolve issues are implemented based upon a particular issue. This feature is described further herein. At step 302, the purchase control system of host system 102 receives an invoice from one of supplier user systems 106. The data standardization component 112 parses the invoice and formats the parsed data using a standardized formatting scheme at step 304. At step 306, an invoice record is created for the invoice. Typical data stored in an invoice record may include supplier information, customer information, product ID, product description, quantity ordered, quantity delivered, unit of sale, cost per unit, total charges, etc.

At step 308, the invoice record is mapped to corresponding records in related databases (e.g., supplier, customer, product/pricing, agreements, etc.) via one or more data fields in a manner similar to that described in FIG. 2. At step 310, it is determined whether the invoice is a duplicate of a previous invoice received at the host system 102. This may occur when a supplier inadvertently sends a duplicate invoice or if the purchase control system inadvertently attempts to re-process an existing invoice. The purchase control system may identify a duplicate invoice by utilizing an algorithm which hashes key data and metadata in the invoice record, and generates a unique value. If the invoice is determined to be a duplicate of an existing invoice, the invoice record for the invoice received at step 302 is marked as ‘duplicate’ in the database at step 312 and a notification of the duplication (if due to supplier error) is generated and transmitted to the supplier at step 314.

If the invoice is considered not to be a duplicate at step 310, the purchase control system evaluates the data in the invoice record for any missing or incomplete information at step 316 (e.g., unit of cost missing; unrecognized product description or identifier, etc.). If the record is incomplete at step 318, the purchase control system retrieves one or more records from related databases (e.g., product/pricing, catalog information, agreements, etc.) to determine whether the information can be obtained elsewhere at step 320. For example, a product description may be provided in the invoice record but a product ID is missing. The purchase control system accesses the product database in storage device 124 for the given supplier identifier and searches for the product description or the closest match to the product description.

At step 322, it is determined whether the missing/incomplete information is found. If so, the missing/correct information is entered into the invoice record at step 324. Once the invoice record is complete, or alternatively, if at step 318 the record is already complete, it is stored in a process queue within host system 102 where it awaits further processing at step 326 and the process continues in FIG. 3B. Additionally, the process returns to step 302 as new invoices are received at the host system 102.

Returning now to step 322, if the missing information is not found elsewhere in storage device 124, the purchase control system generates a notification that specifies what information is needed at step 330 and enters the supplier contact information (e.g., point of contact name, email address, instant messaging address, etc.) at step 332. At step 334, the notification is transmitted via messaging component 120 to the supplier (e.g., one of supplier user systems 106). The purchase control system then assigns an owner (e.g., one of administrative user systems 108) to the invoice record via workflow component 114 and tasks it for follow up at step 336. Alternatively, the owner may be an automated intelligent agent that performs a defined series of steps in order to resolve the issue pending in the invoice record. The invoice record is flagged ‘incomplete’ while the purchase control system waits for a response from the supplier at step 338 or until a resolution is otherwise determined.

The purchase control system monitors the time that the invoice record is in this state (incomplete) at step 340. The purchase control system may be configured such that a preset time limit is used as a triggering event with respect to the invoice record while in this ‘incomplete’ state. At step 342, it is determined whether a response from the supplier has been received. If so, the invoice record is updated to include the missing information at step 324. Otherwise, it is determined whether a threshold time limit has been exceeded at step 344. If not, the purchase control system continues to monitor the state at step 340. Otherwise, the decision support feature of the purchase control services is initiated at step 346. As described above, the decision support feature assesses the error detected in the record and attempts to resolve any issues causing the record to be incomplete or inaccurate. For example, if a cost is missing on a cost/plus agreement, the decision support feature will try to calculate a market-comparable cost for the item, and determine whether a tolerant discrepancy is found. Eventually, the owner may be presented with a screen which tells him/her that the cost was not found, but that a “derived cost” (e.g., an informed guess) was made by the system, and displays that value. At step 348, it is determined whether the decision support feature was successful in resolving the issue. If so, decision support data is developed (e.g., “derived cost”) and presented to the owner with a notification at step 352. If the decision support feature is unsuccessful, the owner is likewise notified at step 352. At this time, the owner takes action to obtain the missing/incomplete information, which may involve, e.g., one or more communications with the supplier. Once the information is obtained (e.g., missing data is received) from the supplier user system 106 at step 342, or as a result of the owner notification at step 352, or as a result of the decision support feature at step 350, the missing/complete information is entered into the invoice record at step 324 and the process continues as shown in FIG. 3A.

Once the invoice record is complete, it is placed in a process queue at the host system 102 where it awaits further processing at step 326. This further processing determines whether any discrepancies exist with respect to the invoices and attempts to resolve the discrepancies, if found, as will now be described in FIG. 3B. In addition, the process continues at step 302 as new invoices are received.

At step 354, an invoice record is selected to process. The purchase control system identifies a price schedule associated with the supplier for the invoice record at step 356 and retrieves the price schedule from the storage device 124. At step 358, the invoice data is compared to the data in the price schedule. This step may involve a simple calculation (e.g., a match is found between corresponding data fields) or may be a very complex analysis whereby various pricing schemes (e.g., rebates, buy backs, etc.), varying time- or volume-based discount programs, and other items need to be parsed and reconciled before a fair comparison can be made.

As a result of the comparison, it is determined whether the invoice data is in conformance with the price schedule at step 360. If so, this means that the supplier's invoice is in compliance with the price schedule received from the supplier (and processed in FIGS. 2A-2B). In this instance, the invoice record is then marked or flagged indicating that the invoice processing is complete at step 362 and the method returns to step 354 whereby the purchase control system selects another invoice record to process.

If however, the invoice data does not conform to the price schedule at step 360, the purchase control system performs a causal analysis at step 364 in order to trouble shoot the discrepancy. For example, suppose that the unit of sale data in the invoice is different than the unit of sale data provided in the price schedule. Or it may be that the unit of sale data was misspelled when the invoice was prepared by the supplier. In either instance, the analysis engine 118 of the purchase control system attempts to resolve the discrepancy using by examining the terms of the price schedule record and the invoice record. Alternatively, other databases may be accessed for determining the cause of the discrepancy. Using the above example, the analysis engine 118 may search for similar supplier information provided in other records maintained for similar types of suppliers to determine if comparable unit of sale data for the same or similar product exists.

As a result of this analysis, it is determined whether a cause is established at step 366. If so, it is then determined whether a resolution is known for the discrepancy (based upon the cause) at step 368. If a resolution is known, the purchase control system automatically resolves the discrepancy (e.g., modifying the unit of sale cost data in the invoice and/or price schedule as needed) at step 370. If a resolution is not known at step 368, the analysis results are recorded in the invoice record for future reference, if needed, at step 372. Various methods may be employed for determining causes and resolutions. For example, a learning algorithm may be employed that reviews historical information (such as the results of analyses recorded in step 372 over time), which tracks solutions that have been tried and successful.

At step 374, an owner (e.g., one of administrative user systems 108, or alternatively, an intelligent agent) is assigned to the invoice record via the workflow component 114 and the invoice record is flagged to reflect ‘resolution pending’ at step 376. The purchase control system tracks the amount of time that the record is pending in this state at step 378. While the record is pending, the owner attempts to acquire the information that would lead to a resolution. This may be implemented via manual analysis of the discrepancy and related data and/or by contact with the supplier, if needed. If a resolution has not been determined at step 380, the workflow component determines if the time threshold has been exceeded at step 382. If so, the owner is notified that a resolution has not been determined and that the record has been in this pending state for an excessive time at step 384. Alternatively, the decision support feature may be initiated to review and resolve the discrepancy in a manner similar to that described in FIG. 3A. If the time limit has not been exceeded at step 382, the process returns to step 378 whereby the status of the record continues to be monitored.

Once the information has been obtained from steps 380 or 384, or alternatively, if the discrepancy has been automatically resolved at step 370, the results are entered into the invoice record at step 386 and the purchase control system re-calculates the items in the invoice to ensure that the invoice (including total charges) correctly reflects the terms of the price schedule.

Returning now to step 366, if a cause is not determined, the purchase control system retrieves the agreement (e.g., contract) relating to the price schedule and the supplier from storage device 124 at step 388. At step 390, the invoice data is compared to the data in the agreement in a manner similar to that described above in step 358. A causal analysis of the discrepancy is performed at step 392 in a manner similar to that described above in step 364. As a result of the analysis, it is determined whether a cause of the discrepancy is known at step 394. If so, it is then determined whether a resolution is known for the discrepancy (based upon the cause) at step 396. If a resolution is known, the purchase control system automatically edits the invoice record to reflect the correct information at step 398. If a resolution is not known at step 396, or alternatively, if a cause cannot be determined at step 394, the analysis results are recorded in the invoice record for future reference, if needed, at step 372 and the process proceeds as described above.

Once the discrepancy is resolved at step 398, or alternatively, once the invoice data has been recalculated at step 386, the purchase control system then generates and transmits a notification of the resolution to the appropriate entities (e.g., the customer and supplier) at step 399 and the process returns to step 362 where the invoice record is flagged as ‘process complete.’ Another invoice record is then selected for processing as the process returns to step 354.

The purchase control system provides an options menu that enables administrative users to select various functions. In addition, the purchase control system enables users to review information particular to the group of database objects associated with the system (e.g., customer, manufacturer, products, etc.). A sample computer screen 400 including a quick pick menu 402 and an options menu 404 are shown in FIG. 4. An administrative user who is tasked with invoice resolution selects this option 406 from the options menu 404 as shown in FIG. 4.

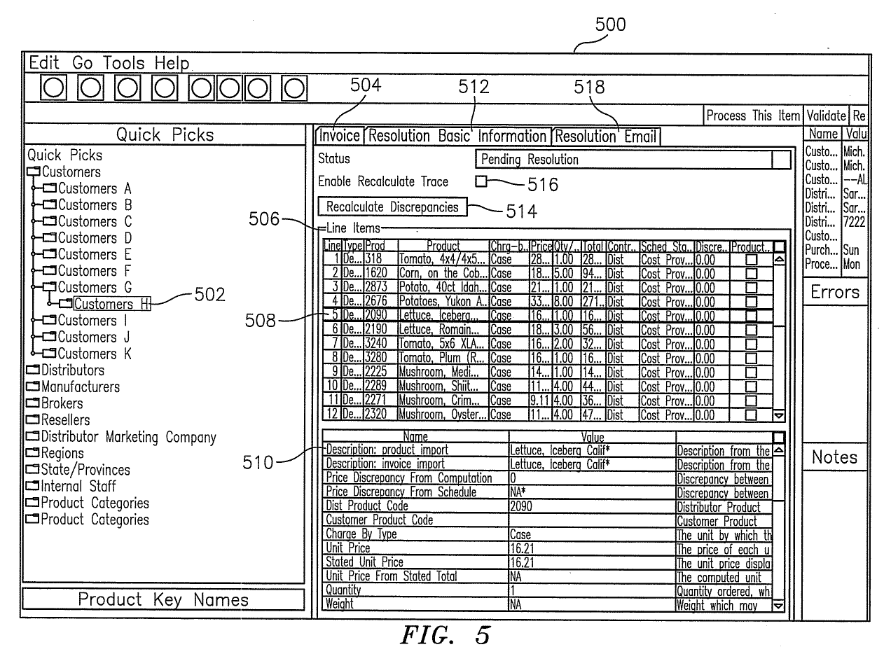

As shown in FIG. 5, a computer screen 500 illustrates an invoice record retrieved by an administrative user for a particular supplier and customer (customer H 502). The administrative user has selected the invoice tab 504 and a subwindow 506 presents a listing of invoice items. The user may obtain more detailed information by selecting a particular line item (e.g., line item 508 as shown in FIG. 5). Once selected, another subwindow 510 displays the detail relating to the line item selected. This information may be reviewed by the administrative user in an attempt to ascertain the cause of the discrepancy determined by the purchase control system. If this information is not helpful to the user, he/she may select the ‘Resolution Basic Information’ tab 512. Upon selecting this tab 512, the results of the analysis recorded in FIG. 3 is provided which outlines each of the steps implemented by the purchase control system in evaluating the discrepancy. This information may further include a possible resolution (intelligent guess) for the discrepancy.

The administrative user may manually review the price schedule and/or agreement if needed to resolve the discrepancy. If an error is detected, e.g., in the data entry of the invoice, the administrative user may correct the data and select ‘Recalculate Discrepancy’ option 514 which causes the purchase control system to recalculate the invoice information. If, upon recalculation, the invoice data conforms to the price schedule data, the new data may be accepted into the invoice record and a notification generated and transmitted to the supplier/customer.

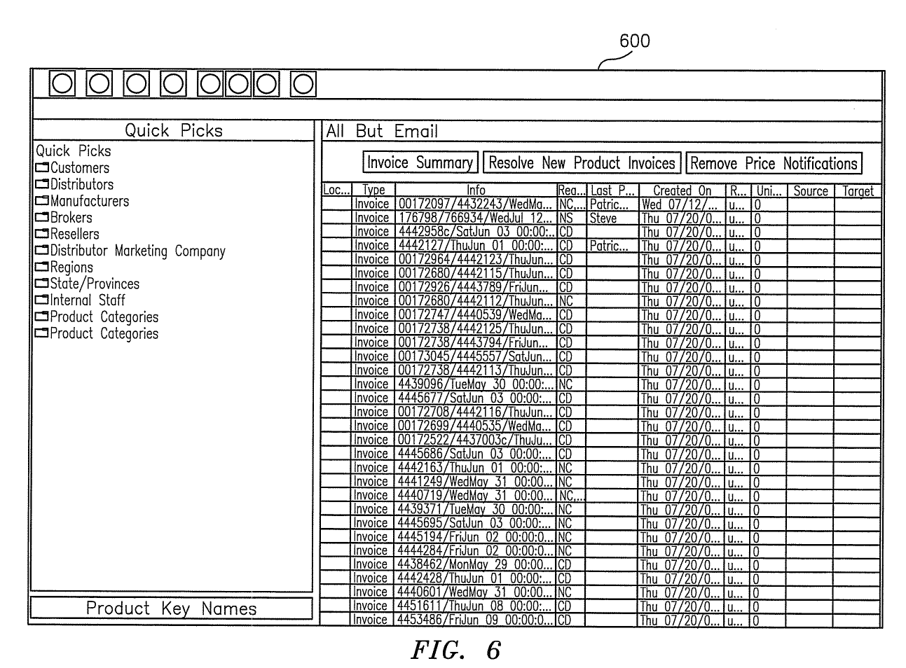

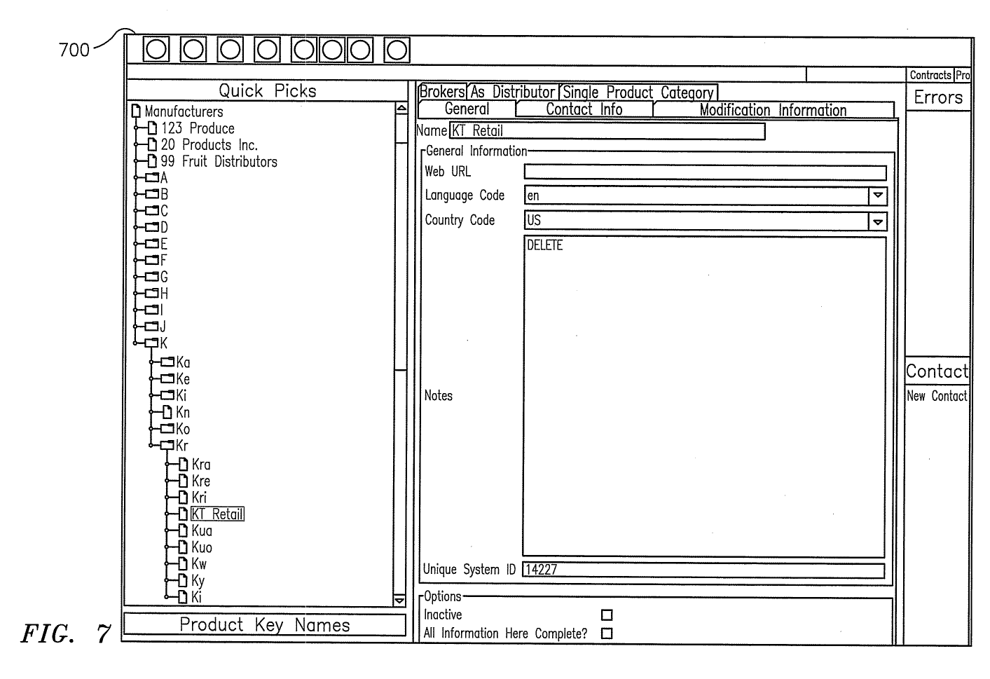

In addition to the invoice resolution functions described above, the purchase control system also enables an administrative user to perform new product invoice resolution activities as shown generally in FIG. 6. Also, the purchase control system provides other features and functions in addition to the invoice resolution. For example, FIG. 7 illustrates a computer screen whereby customer records may be managed.

Many other features are available via the purchase control system. It will be understood that the features described above are provided for illustrative purposes and are not to be construed as limiting in scope.

As described above, the invention can be embodied in the form of computer-implemented processes and apparatuses for practicing those processes. In exemplary embodiments, the invention is embodied in computer program code executed by one or more network elements. Embodiments include computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. Embodiments include computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

1. A method for implementing purchase control services, comprising:
generating a record for a business agreement established between a customer entity and a supplier entity, and entering terms of the business agreement into corresponding data fields in the record;
linking key data fields in the record to one or more information sources including at least one of a supplier record, customer record, product database, and pricing schedule;
storing the record in a database; and
in response to receiving an item from the supplier entity:
creating a standardized record for the item;
mapping the standardized record to at least one of the information sources and the record;
reviewing the item for missing and incorrect data and, if discovered, supplying the missing or correct data to the standardized record from at least one of the information sources and an assigned owner of the standardized record;
comparing data in the standardized record with data provided in one of the pricing schedule and the record; and
resolving discrepancies, if discovered, in response to the comparing, by at least one of:
causal analysis using historical data; and
notification and review by the assigned owner of the standardized record; and
updating the standardized record in response to resolving the discrepancies.

2. The method of claim 1, wherein the item is the pricing schedule, the method further comprising:
verifying effective dates of the standardized record corresponding to the pricing schedule and flagging the standardized record if the effective dates are not current; and
retrieving the record corresponding to the pricing schedule if the effective dates are current;
wherein comparing data in the standardized record to data provided in the record includes comparing at least one of:
supplier entity data;
customer entity data;
product ID;
product description;
quantity of product ordered;
quantity of product delivered;
unit of sale; and
cost per unit.

3. The method of claim 2, further comprising:
analyzing pricing schemes including buybacks, rebates, and varying time-based discount programs and volume-based discount programs;
wherein resolving the discrepancies includes determining a resolution based upon results of the analyzing.

4. The method of claim 3, wherein resolving the discrepancies includes:
modifying data in the standardized record to form with the corresponding data in the record;
notifying a designated entity of the resolution; and
recording resolution details in the standardized record.

5. The method of claim 1, wherein the missing and incorrect data corresponds to at least one of:
missing unit of cost;
incorrect unit of cost;
missing product description;
unrecognized product description;
missing product identifier; and
unrecognized product identifier.

6. The method of claim 1, wherein the item is an invoice record, the method further comprising:
retrieving a pricing schedule for the supplier entity;
wherein comparing data in the standardized record corresponding to the invoice record with data provided in the pricing schedule includes comparing at least one of:
supplier entity data;
customer entity data;
product ID;
product description;
quantity of product ordered;
quantity of product delivered;
unit of sale; and
cost per unit.

7. The method of claim 6, wherein resolving the discrepancies includes modifying at least one of the standardized records corresponding to one of the invoice record and the price schedule to conform with the other of the standardized records.

8. A system for implementing purchase control services, comprising:
a host system implementing a purchase control application, the purchase control application performing a method, comprising:
generating a record for a business agreement established between a customer entity and a supplier entity, and entering terms of the business agreement into corresponding data fields in the record;
linking key data fields in the record to one or more information sources including at least one of a supplier record, customer record, product database, and pricing schedule;
storing the record in a database; and
in response to receiving an item from the supplier entity:
creating a standardized record for the item;
mapping the standardized record to at least one of the information sources and the record;
reviewing the item for missing and incorrect data and, if discovered, supplying the missing or correct data to the standardized record from at least one of the information sources and an assigned owner of the standardized record;
comparing data in the standardized record with data provided in one of the pricing schedule and the record; and
resolving discrepancies, if discovered, in response to the comparing, by at least one of:
causal analysis using historical data; and
notification and review by the assigned owner of the standardized record; and
updating the standardized record in response to resolving the discrepancies.

9. The system of claim 8, wherein the item is the pricing schedule, the method further comprising:
verifying effective dates of the standardized record corresponding to the pricing schedule and flagging the standardized record if the effective dates are not current; and
retrieving the record corresponding to the pricing schedule if the effective dates are current;
wherein comparing data in the standardized record to data provided in the record includes comparing at least one of:
supplier entity data;
customer entity data;
product ID;
product description;
quantity of product ordered;
quantity of product delivered;
unit of sale; and
cost per unit.

10. The system of claim 9, wherein the purchase control application further performs:
analyzing pricing schemes including buybacks, rebates, and varying time-based discount programs and volume-based discount programs;
wherein resolving the discrepancies includes determining a resolution based upon results of the analyzing.

11. The system of claim 10, wherein resolving the discrepancies includes:
modifying data in the standardized record to form with the corresponding data in the record;
notifying a designated entity of the resolution; and
recording resolution details in the standardized record.

12. The system of claim 8, wherein the missing and incorrect data corresponds to at least one of:
missing unit of cost;
incorrect unit of cost;
missing product description;
unrecognized product description;
missing product identifier; and
unrecognized product identifier.

13. The system of claim 8, wherein the item is an invoice record, the method further comprising:
retrieving a pricing schedule for the supplier entity;
wherein comparing data in the standardized record corresponding to the invoice record with data provided in the pricing schedule includes comparing at least one of:
supplier entity data;
customer entity data;
product ID;
product description;
quantity of product ordered;
quantity of product delivered;
unit of sale; and
cost per unit.

14. The system of claim 13, wherein resolving the discrepancies includes modifying at least one of the standardized records corresponding to one of the invoice record and the price schedule to conform with the other of the standardized records.

15. A computer program product for implementing purchase control services, the computer program product including instructions for causing a computer to implement a method, the method comprising:
generating a record for a business agreement established between a customer entity and a supplier entity, and entering terms of the business agreement into corresponding data fields in the record;
linking key data fields in the record to one or more information sources including at least one of a supplier record, customer record, product database, and pricing schedule;
storing the record in a database; and
in response to receiving an item from the supplier entity:
creating a standardized record for the item;
mapping the standardized record to at least one of the information sources and the record;
reviewing the item for missing and incorrect data and, if discovered, supplying the missing or correct data to the standardized record from at least one of the information sources and an assigned owner of the standardized record;
comparing data in the standardized record with data provided in one of the pricing schedule and the record; and
resolving discrepancies, if discovered, in response to the comparing, by at least one of:
causal analysis using historical data; and
notification and review by the assigned owner of the standardized record; and
updating the standardized record in response to resolving the discrepancies.

16. The computer program product of claim 15, wherein the item is the pricing schedule, the method further comprising:
verifying effective dates of the standardized record corresponding to the pricing schedule and flagging the standardized record if the effective dates are not current; and
retrieving the record corresponding to the pricing schedule if the effective dates are current;
wherein comparing data in the standardized record to data provided in the record includes comparing at least one of:
supplier entity data;
customer entity data;
product ID;
product description;
quantity of product ordered;
quantity of product delivered;
unit of sale; and
cost per unit.

17. The computer program product of claim 16, further including instructions for performing:
analyzing pricing schemes including buybacks, rebates, and varying time-based discount programs and volume-based discount programs;
wherein resolving the discrepancies includes determining a resolution based upon results of the analyzing.

18. The computer program product of claim 17, wherein resolving the discrepancies includes:
modifying data in the standardized record to form with the corresponding data in the record;
notifying a designated entity of the resolution; and
recording resolution details in the standardized record.

19. The computer program product of claim 15, wherein the missing and incorrect data corresponds to at least one of:
missing unit of cost;
incorrect unit of cost;
missing product description;
unrecognized product description;
missing product identifier; and
unrecognized product identifier.

20. The computer program product of claim 15, wherein the item is an invoice record, the method further comprising:
retrieving a pricing schedule for the supplier entity;
wherein comparing data in the standardized record corresponding to the invoice record with data provided in the pricing schedule includes comparing at least one of:
supplier entity data;
customer entity data;
product ID;
product description;
quantity of product ordered;
quantity of product delivered;
unit of sale; and
cost per unit.
